(19) United States
(12) Patent Application Publication
(10) Pub. No.: US 2014/0163933 A1
(43) Pub. Date: Jun. 12, 2014

(54) MANUFACTURING LINE DESIGNING APPARATUS AND MANUFACTURING LINE DESIGNING METHOD

(71) Applicants: Hisaya Ishibashi, Tokyo (JP); Takahiro Nakano, Tokyo (JP); Satoshi Nagahara, Tokyo (JP)

(72) Inventors: Hisaya Ishibashi, Tokyo (JP); Takahiro Nakano, Tokyo (JP); Satoshi Nagahara, Tokyo (JP)

(21) Appl. No.: 14/236,986

(22) PCT Filed: May 24, 2012
(86) PCT No.: PCT/JP2012/063379

§ 371 Date: Feb. 4, 2014

(30) Foreign Application Priority Data
Sep. 16, 2011 (JP) 2011-202525

(51) Int. Cl. G06F 17/50

(52) U.S. Cl. CPC G06F 17/50
USPC 703/1

(57) ABSTRACT

Conventional manufacturing line designing had a problem in that, when making the number of places for keeping partly-finished products (number of buffers) more appropriate in a factory layout, calculation took considerable time because a design proposal was selected through trial and error and a manufacturing line simulation was executed each time a design proposal was selected. A manufacturing line designing apparatus according to the present invention is characterized in being provided with: a production simulation execution unit that predicts future production capacity and the number of partly-finished products by simulating a manufacturing line; a buffer utilization rate calculation unit that calculates a buffer utilization rate that is the ratio of the number of buffers for each of the processes with respect to the maximum number of buffers and the average number of buffers during the simulation period; and a number-of-buffers reducing unit that reduces the number of buffers successively, starting from a process having a low buffer utilization rate, and repeats the calculation until the total number of buffers is minimized, to determine the number of buffers to be placed between the processes.

### TECHNICAL FIELD

The present invention relates to manufacturing line designing of individual order-received products such as industrial machinery, motors, turbines and so forth, and relates to a technical field of a manufacturing line designing apparatus and a manufacturing line designing method relating to appropriate adjustment of the number of partly-finished products (that is, the number of works in progress) (the number of buffers) in a partly-finished product keeping place in a factory layout.

### BACKGROUND ART

In manufacturing line designing for establishing a new manufacturing line, design factors such as the number of facilities, the factory layout, a cycle time and so forth are determined aiming to attain a target production amount and to reduce the number of partly-finished products. In particular, in case of targeting a large-sized machine assembled product, appropriate adjustment of the number of partly-finished products (the number of buffers) in the partly-finished product keeping place in designing the factory layout becomes an important subject from the viewpoint of transportation of the partly-finished products and insurance of the keeping place. Specifically, when the number of buffers is reduced, a shortage of inter-process partly-finished products occurs due to variation factors such as facility failures and so forth and other facilities cannot work in a failure period of a failed facility concerned, and it sometimes occurs that the target production amount cannot be attained. In addition, when the number of buffers is increased, useless partly-finished products are left and earning is deteriorated. Therefore, it is necessary to design the number of buffers on the basis of the number of partly-finished products with which the target production amount is attained and which is appropriate.

As a technology for evaluating the production amount and the number of partly-finished products in manufacturing line designing, there is a manufacturing line simulation. For example, in Patent Literature 1, there is described a technology of evaluating manufacturing line capacity that a simulation is executed by virtually modelling a manufacturing line to predict behaviors of work pieces flowing in the line and setting in advance a target number of buffers so as to evaluate the degree of attainment of the production amount, and in a case where a target production amount is not attained, the simulation is executed by re-setting the target number of buffers so as to make it possible to confirm improvement in production amount.

### CITATION LIST

### Patent Literature

Patent Literature 1: Japanese Patent Application Laid-Open No. 2002-244716

### SUMMARY OF INVENTION

### Problems to be Solved by the Invention

In the above-mentioned Patent Literature 1, since the production amount is evaluated by preparing the buffer of the manufacturing line through trial and error and performing the manufacturing line simulation each time, there was such a problem that a design evaluation time is long. For example, a design variable in buffer designing is a buffer before each process, and when the number of processes is increased, combinations of the buffers before each process are exponentially increased. For example, a manufacturing line that the number of processes is 10 is conceived. Here, as a simple example, it is conceived to study two sets of buffer numbers of 1 and 0 for the buffers before each process. In this case, the number of combinations, that is, the number of buffer design proposals amounts to 210 (1024). Here, in a case where a time required for one evaluation of the manufacturing line simulation is about one hour, a design evaluation time amounts to 1024 hours (about 43 days) from the product of a required time (about 1 hour) for one evaluation of the design proposal and the number of design proposals (1024). Since lengthening of the design evaluation time leads to lengthening of a manufacturing line design period, a reduction in design evaluation time of the number of buffers is a subject.

Therefore, the present invention aims to provide a means for implementing designing of the number of buffers in a short time by targeting designing of a maximum capacity (the number of buffers) of a partly-finished product keeping place in a factory layout and newly defining a design index for deciding use and disuse of each buffer.

### Means for Solving the Problems

In order to solve the above-mentioned subjects, in the present invention, a manufacturing line designing apparatus that designs the number of buffers of a manufacturing line is configured by including a production simulation execution unit planning the progress of work of all products in information on future predicted orders to be received and preparing work history information, a buffer utilization rate calculation unit calculating an amount of partly-finished products, a maximum buffer utilization rate, an average buffer utilization rate and a production amount of buffers before each process from the work history information, a number-of-buffers increasing execution unit re-executing the process of the aforementioned production simulation execution unit by increasing the number of buffers before process that the average utilization rate is larger than an upper limit threshold value in a case where the aforementioned production amount does not attain a target production amount, a number-of-buffers reducing execution unit re-executing the process of the aforementioned production simulation execution unit by using the number of buffers before process that the maximum buffer utilization rate is smaller than 1 as a maximum number of partly-finished products, or by reducing the number of buffers before process that the average buffer utilization rate is smaller than a lower limit threshold value in a case where the aforementioned production amount has attained the target production amount and an execution result display unit outputting a result of final simulation and the number of buffers before each process when no increasable or reducible buffer is left and the aforementioned process has been finished.

In addition, in order to solve the above mentioned subjects, in the present invention, in a manufacturing line designing method, a production simulation of sequentially allocating all products to usable facilities by the amount for a work time, on the basis of information on all object products, object work processes, object facilities and object work times in information on future predicated orders to be received, and preparing work history information that times at which the products are partly finished in the facilities or buffers before process are recorded in accordance with progress of time is performed, the aforementioned production simulation process is re-executed by calculating a maximum number of partly-finished products WIP_{MAX,i} and an average number of partly-finished products WIP_{AVE,i} of buffers before each process i from the aforementioned work history information, calculating a maximum buffer utilization rate α_{NAX,i} and an average buffer utilization rate α_{AVE,i} of the buffers before process i by dividing the maximum number of partly-finished products WIP_{MAX,i} and average number of partly-finished products WIP_{AVE,i} by the number of buffers before the process i N_{Buffer,i}, and calculating an average production amount in an object period from the aforementioned work history information, and in a case where the aforementioned production amount does not attain a target production amount, increasing the number of buffers before process that the average buffer utilization rate is larger than an upper limit threshold value, the aforementioned production simulation process is re-executed by using the number of buffers before process that the maximum buffer utilization rate is smaller than 1 as the maximum number of partly-finished products, or by reducing the number of buffers before process that the average buffer utilization rate is smaller than a lower limit threshold value in a case where the aforementioned production amount has attained the target production amount and a result of final simulation and the number of buffers before each process when no increasable or reducible buffer is left and the aforementioned process has been finished are outputted.

### Advantages of the Invention

According to the present invention, it becomes possible to derive a minimum number of buffers in a short time in designing the number of buffers in the factory layout. Thus, manufacturing line designing capable of attaining the target production amount and maintaining a minimum number of partly-finished products becomes possible.

Subjects, configurations and advantages other than the above-mentioned ones will become apparent from the following description of embodiments.

### BRIEF DESCRIPTION OF DRAWINGS

FIG. 1 is a schematic diagram showing one example of a work process in a manufacturing field.

FIG. 2 is a diagram showing a schematic diagram of a manufacturing line designing apparatus which is one embodiment of the present invention.

FIG. 3 is a diagram showing information on orders received which is one embodiment of the present invention.

FIG. 4 is a diagram showing work process route information which is one embodiment of the present invention.

FIG. 5 is a diagram showing facility information which is one embodiment of the present invention.

FIG. 6 is a diagram showing product keeping place information which is one embodiment of the present invention.

FIG. 7 is a diagram showing work time information which is one embodiment of the present invention.

FIG. 8 is a diagram showing work history information which is one embodiment of the present invention.

FIG. 9 is a diagram showing a hardware configuration which is one embodiment of the present invention.

FIG. 10 is a flowchart showing a process of determining the number of buffers of a manufacturing line designing apparatus which is one embodiment of the present invention.

FIG. 11 is a flowchart showing a process of executing a manufacturing line simulation of the manufacturing line designing apparatus which is one embodiment of the present invention.

FIG. 12 is a flowchart showing a process of a buffer utilization rate calculation unit of the manufacturing line designing apparatus which is one embodiment of the present invention.

FIG. 13 is a flowchart showing a process of a number-of-buffers increasing execution unit of the manufacturing line designing apparatus which is one embodiment of the present invention.

FIG. 14 is a flowchart showing a process of a number-of-buffers reducing execution unit of the manufacturing line designing apparatus which is one embodiment of the present invention.

FIG. 15 is an output result of the number of buffer designs which is one embodiment of the present invention.

FIG. 16 is an output result of the number of buffer designs which is one embodiment of the present invention.

FIG. 17 is an output result of the number of buffer designs which is one embodiment of the present invention.

FIG. 18 is an output result of the number of buffer designs which is one embodiment of the present invention.

FIG. 19 is an output result of the number of buffer designs which is one embodiment of the present invention.

### MODES FOR CARRYING OUT THE INVENTION

In the following, one embodiment of the present invention will be described.

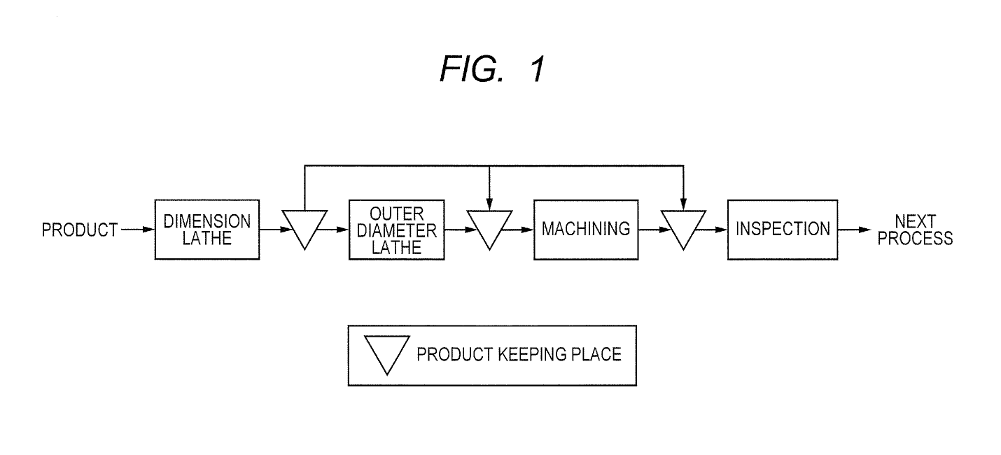

In the present invention, designing of the number of buffers in a factory layout is intended as an object. FIG. 1 is an example of a work process flow in a certain manufacturing work field. In the following, details of the present invention will be described by intending the present example as the object. As shown in FIG. 1, there are work processes named as a dimension lathe, an external form lathe and so forth in the work process flow of a target manufacturing work field, and there exists a part keeping place between respective processes. In a manufacturing line designing apparatus in the present embodiment, for example, a maximum capacity (the number of buffers) for placing partly-finished products in each part keeping place between the work processes in the manufacturing line is calculated so as to provide it to a user.

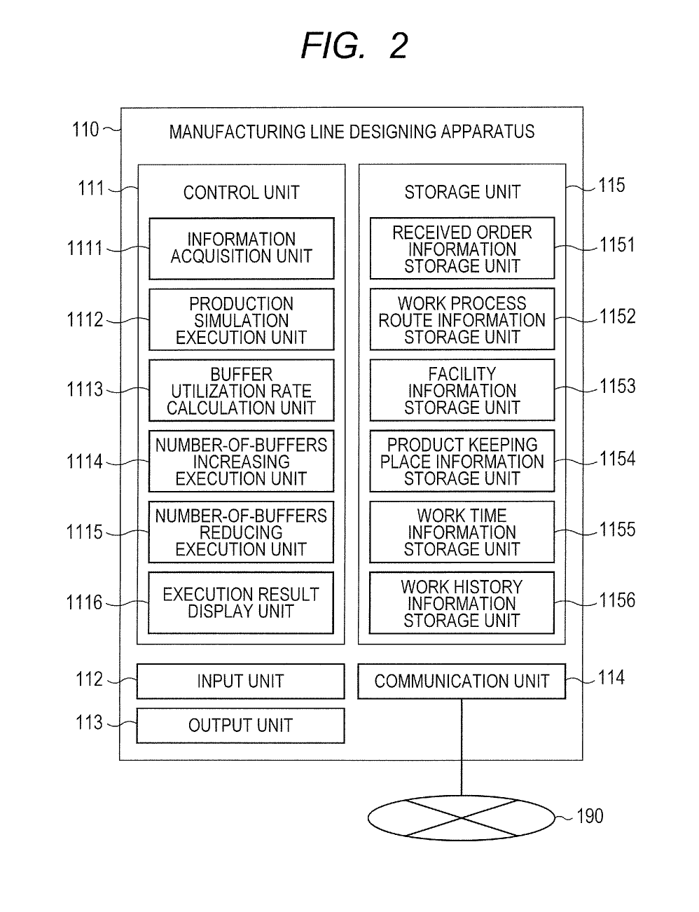

FIG. 2 is a schematic diagram of a manufacturing line designing apparatus 110. As shown in the drawing, the manufacturing line designing apparatus 110 is provided with a control unit 111, an input unit 112, an output unit 113, a communication unit 114 and a storage unit 115. In addition, the control unit 111 is provided with an information acquisition unit 1111, a production simulation execution unit 1112, a buffer utilization rate calculation unit 1113, a number-of-buffers increasing execution unit 1114, a number-of-buffers reducing execution unit 1115 and an execution result display unit 1116.

The input unit 112 accepts input of information. The output unit 113 outputs information. The communication unit 114 performs information transmission and reception over a network 190. The storage unit 115 is provided with a received orders information storage unit 1151, a work process route information storage unit 1152, a facility information storage unit 1153, a part keeping place information storage unit 1154, a work time information storage unit 1155 and a work history information storage unit 1156.

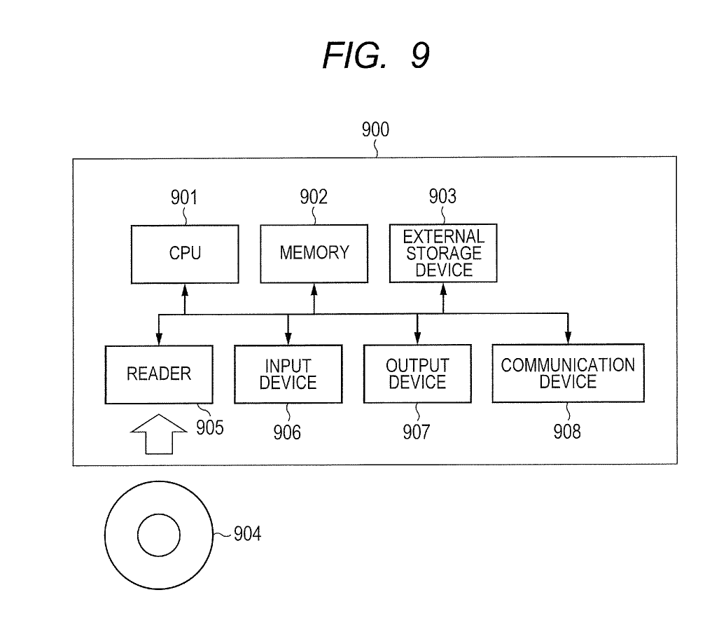

The manufacturing line designing apparatus 110 described in FIG. 2 can be implemented by a general computer 900 which is provided with a CPU (Central Processing Unit) 901, a memory 902, an external storage device 903 such as an HDD (Hard Disk Drive) or the like, a reader 905 for reading and writing information from and into a portable storage medium 904 such as a CD (Compact Disk), a DVD (Digital Versatile Disk) or the like, an input device 906 such as a keyboard, a mouse or the like, an output device 907 such as a display or the like, and a communication device 908 such as an NIC (Network Interface Card) or the like for connection to a communication network, for example, as shown in FIG. 9 (a schematic diagram of the computer 900).

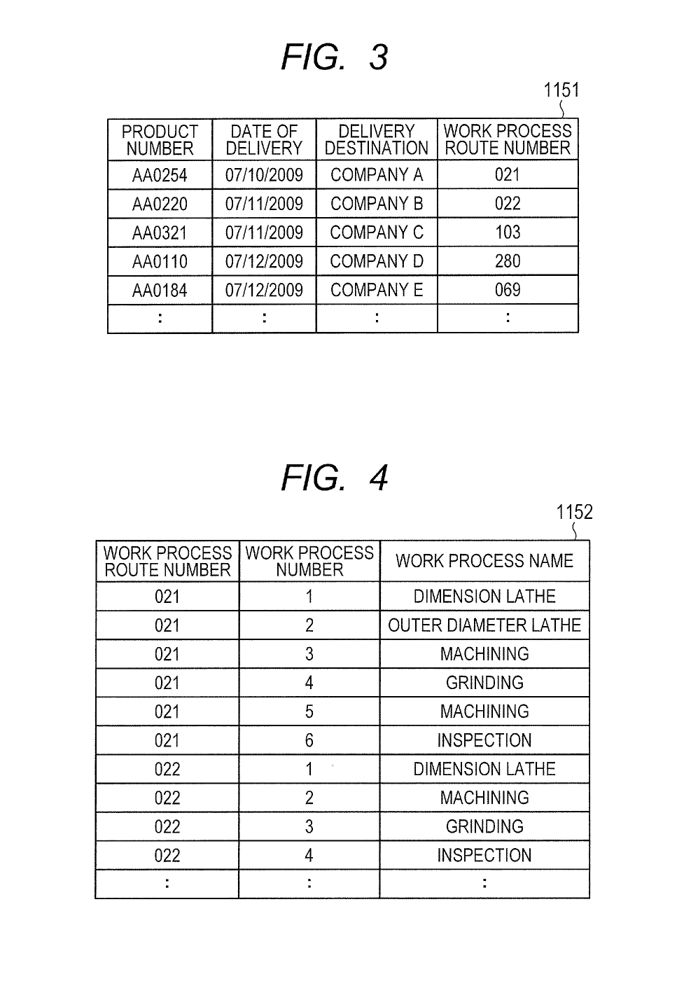

FIG. 3 is a diagram showing one embodiment of a file format of the received orders information storage unit 1151 described in FIG. 2. In FIG. 3, the file format 1151 is provided with a field for registering a product number which is an identification number which is numbered when an order has been received from a delivery destination who is a customer, a field for registering the date of delivery that a product is to be shipped to the delivery destination, a field for registering the delivery destination of the customer, and a field for registering a work process route number which is an identification number of a work process route along which the product is manufactured.

FIG. 4 is a diagram showing one embodiment of a file format of the work process route information storage unit 1152 described in FIG. 2. In FIG. 4, the file format 1152 is provided with a field for registering the work process route number which is the identification number of the work process route which has been patterned in advance for every kind of product, a field for registering a work process number indicating the order of a work process in the work process route and a field for registering a work process name indicating the name of the work process.

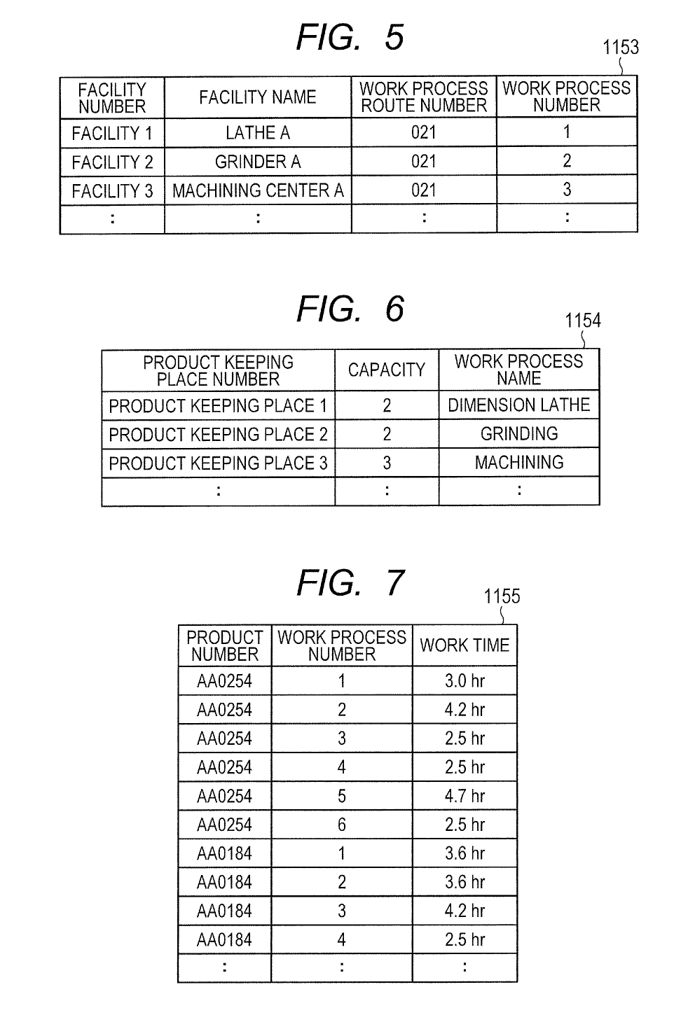

FIG. 5 is a diagram showing one embodiment of a file format of the facility information storage unit 1153 described in FIG. 2. In FIG. 5, the file format 1153 is provided with a field for registering a facility number, a field for registering the name of the corresponding facility, a field for registering a work process route number that the corresponding facility is to be used and a field for registering a number of a work process in the work process route that the corresponding facility is to be used.

FIG. 6 is a diagram showing one embodiment of a file format of the product keeping place information storage unit 1154 described in FIG. 2. In FIG. 6, the file format 1154 is provided with a field for registering a product keeping place number which is an identification number of a product keeping place, a field for registering the capacity of the product keeping place of the corresponding number and a field for registering a work process name corresponding to the corresponding product keeping place number.

FIG. 7 is a diagram showing one embodiment of a file format of the work time information storage unit 1155 described in FIG. 2. In FIG. 7, the file format 1155 is provided with a field for registering the product number which is the identification number which is numbered when the order has been received from the delivery destination who is the customer, a field for registering the work process number of the work process that the product of the corresponding number needs a manufacturing process and a field for registering a work time required in the work process that the product of the corresponding number is subjected to the manufacturing process.

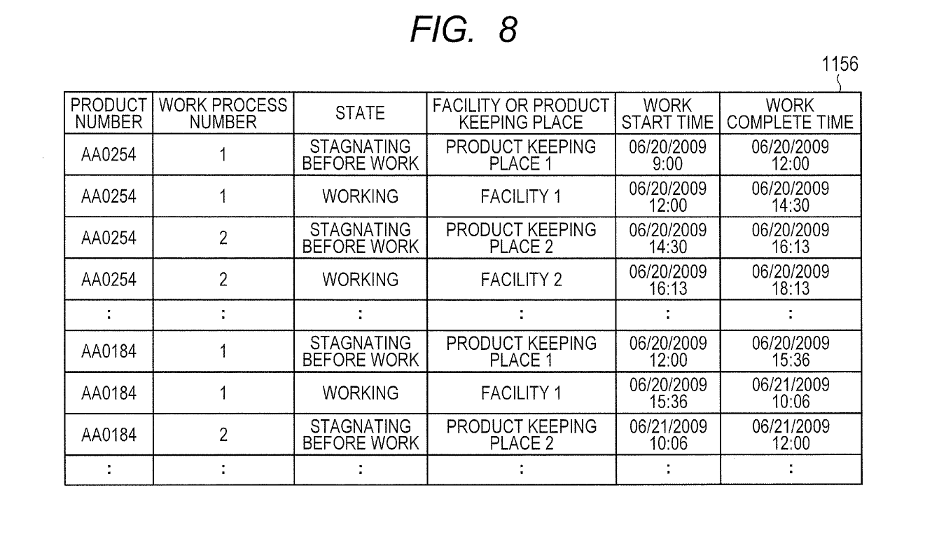

FIG. 8 is a diagram showing one embodiment of a file format of the work history information storage unit 1156 described in FIG. 2. In FIG. 8, the file format 1156 is provided with a field for registering the production number which is the identification number which is numbered when the order has been received from the delivery destination who is the customer, a field for registering the number of a work process that the product of the corresponding number is currently being partly finished, a field for registering a state of the process of the product of the corresponding number, a field for registering a number of a facility or a product keeping place that the product of the corresponding number is currently being partly finished, a field for registering a time that work has been started in the facility or the product keeping place of the corresponding number that the product of the corresponding number is currently being partly finished, and a field for registering a time that the work has been terminated in the facility or the product keeping place of the corresponding number that the product of the corresponding number is currently being partly finished.

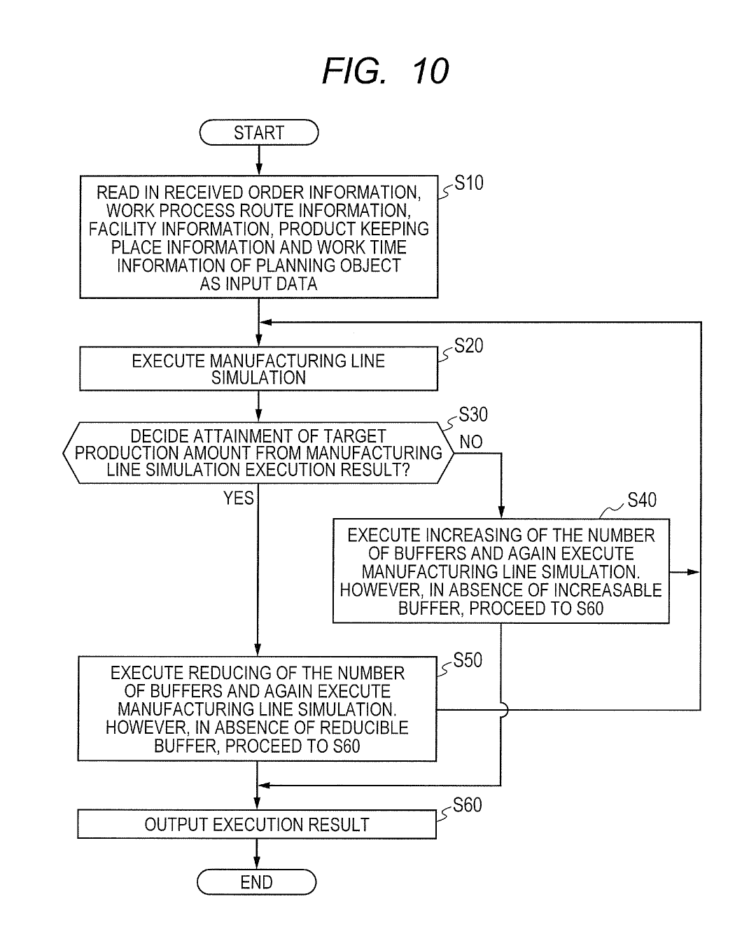

Next, a processing program that the manufacturing line designing apparatus 110 pertaining to the present invention executes will be described in order using FIG. 10.

FIG. 10 is a flowchart showing a process of determining the number of buffers that the manufacturing line designing apparatus 110 pertaining to the present invention executes.

First, the information acquisition unit 1111 reads in information on received orders of future predicted planning objects, work process route information, facility information, product keeping place information and work time information as input data from the storage unit 115 (S10).

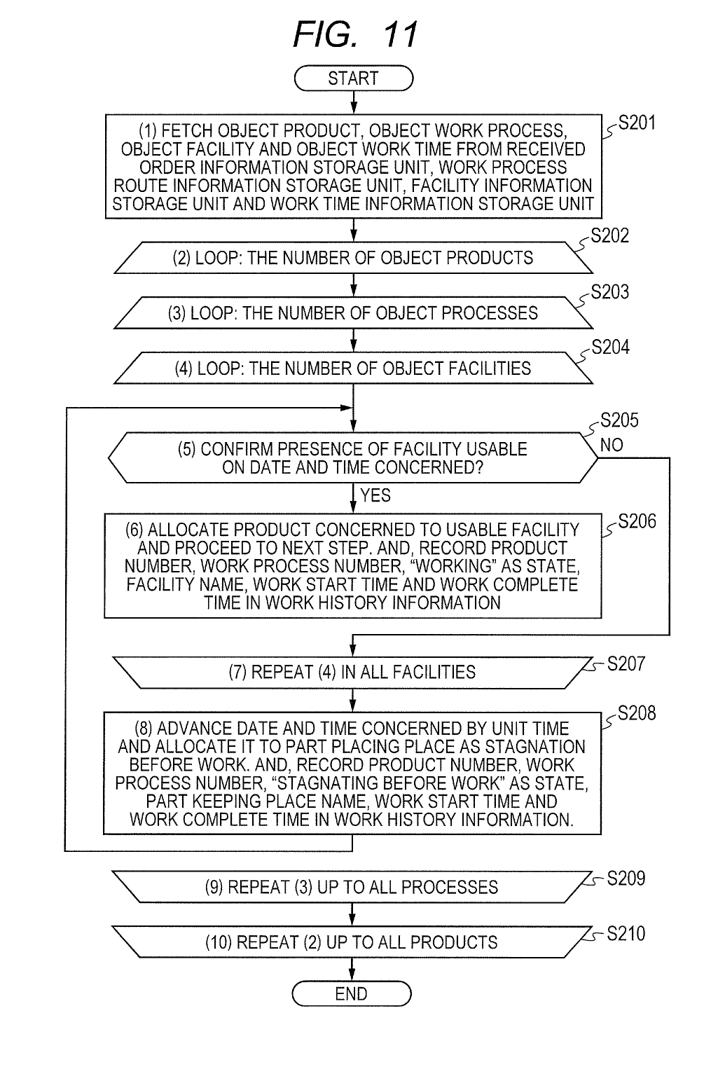

Next, the production simulation execution unit 1112 executes a production simulation from the present time to the future (S20). Incidentally, details of this step S20 will be described using FIG. 11.

Next, in the buffer utilization rate calculation unit 1113, a buffer utilization rate is calculated from a result of execution of the production line simulation to decide attainment of a target production amount (S30).

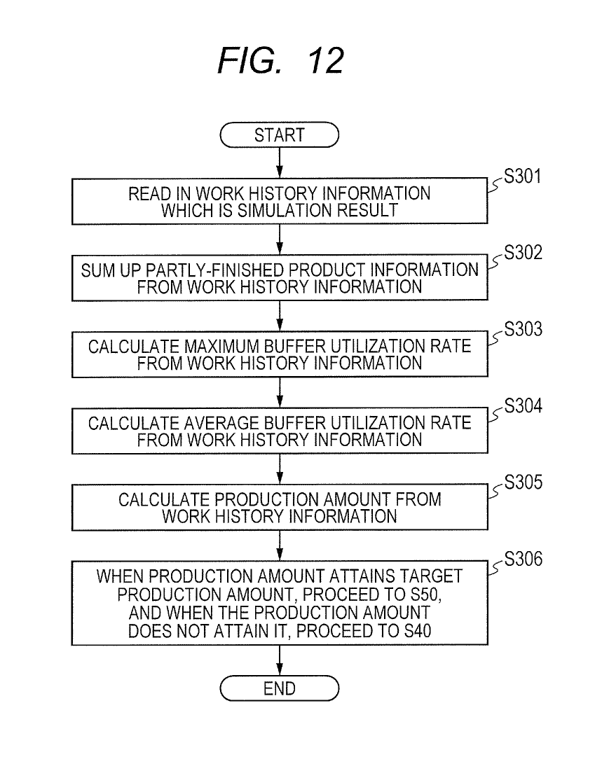

Incidentally, details of this step S30 will be described using FIG. 12.

Next, the number-of-buffers increasing execution unit 1114 executes increasing of the number of buffers in a case where the target production amount is not attained and again executes the manufacturing line simulation (S40). However, it is terminated in the absence of increasable buffers.

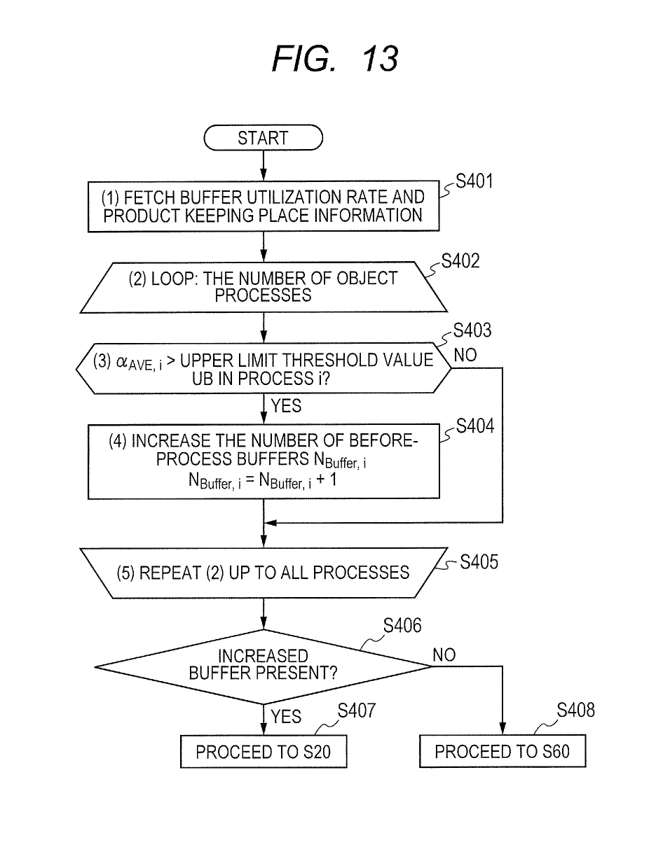

Incidentally, details of this step S40 will be described using FIG. 13.

Next, the number-of-buffers reducing execution unit 1115 executes reducing of the number of buffers and executes again the manufacturing line simulation. However, it is terminated in the absence of reducible buffers (S50).

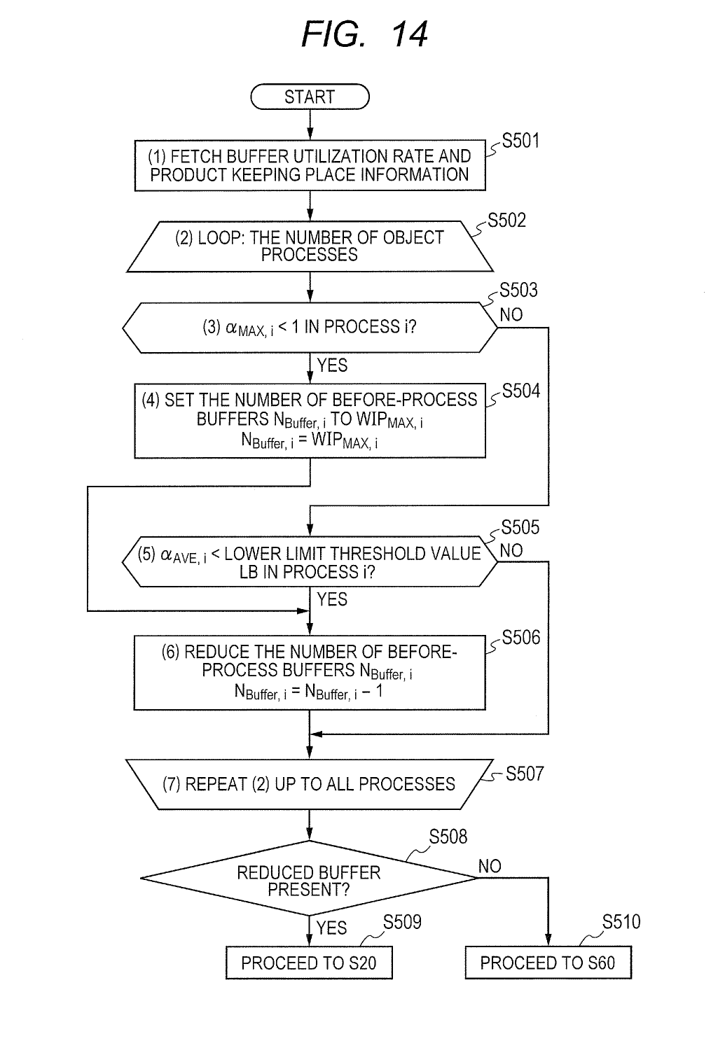

Incidentally, details of this step S50 will be described in detail using FIG. 14.

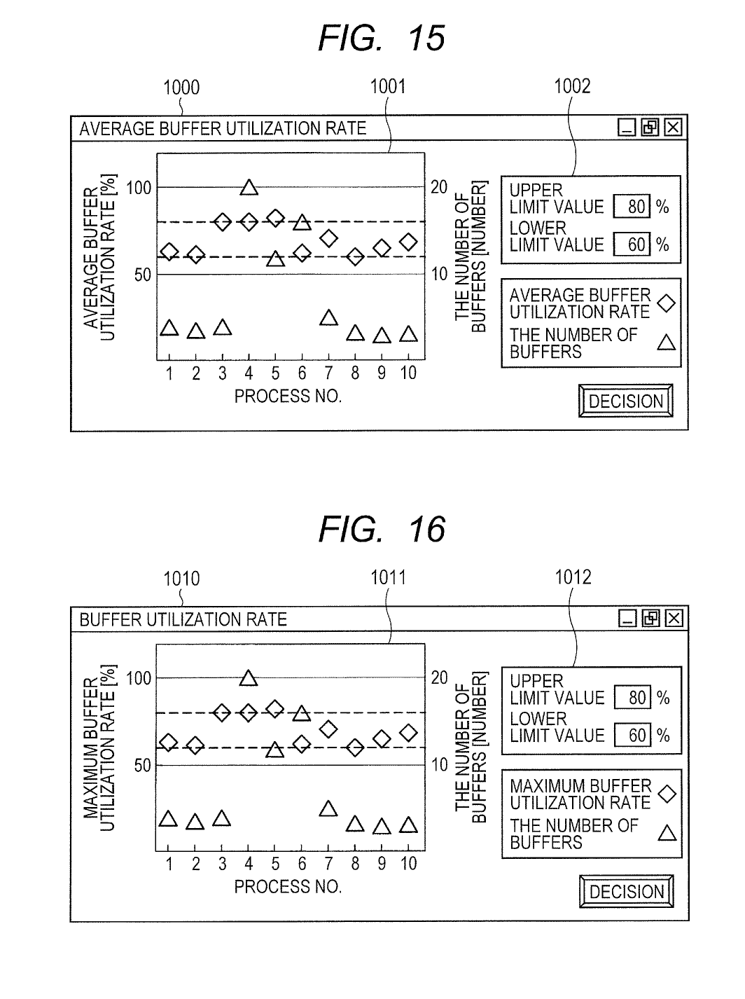

Next, the execution result display unit 1116 displays a result of calculations performed up to step S50 (S60). Incidentally, details of this step S60 will be described in detail using FIGS. 15, 16, 17, 18 and 19.

FIG. 11 is a flowchart showing a process of executing the manufacturing line simulation in step S20 in FIG. 10.

First, the production simulation execution unit 1112 fetches information on an object product, an object work process, an object facility and an object work time from the received orders information storage unit 1151, the work process route information storage unit 1152, the facility information storage unit 1153 and the work time information storage unit 1155 which are stored in the storage unit 115 (S201).

Next, the production simulation execution unit 1112 repeats processing steps S203 to S209 by the number of all products in order to form a plan (a plan of allocation to facilities) of all of the products stored in the received orders information storage unit 1151 (S202).

Next, the production simulation execution unit 1112 repeats processing steps S204 to S208 by the number of all processes in order to form a plan for the object product (S203).

Next, the production simulation execution unit 1112 repeats processing steps S205 to S206 by the number of facilities corresponding to the object process (S204).

Next, the production simulation execution unit 1112 confirms whether a facility which is usable on the corresponding date and time of the object product and the object process is present (S205).

When the usable facility is present, the production simulation execution unit 1112 proceeds to step S206 and allocates the corresponding products to the usable facility by the number for a work time on the corresponding date and time, then proceeds to step S203 and handles the next process as an object (S206). In addition, in that case, it records the product number, the work process number, “Working” as the state, the facility mane, the work start time and the work complete time in the work history information storage unit 1156.

In addition, the production simulation execution unit 1112 proceeds to step S207 when any usable facility is not present and repeats it in all of the object facilities. When there is no usable facility in all of the facilities, it proceeds to step S208, advances the corresponding date and time by a unit time (S208) and proceeds to step S205. In addition, at that time, it records the product name, the work process number, “Stagnating Before Work” as the state, the part keeping place name, the work start time and the work complete time in the work history information storage unit 1156.

The above-mentioned production simulation execution unit 1112 repeats processing steps S204 to S208 by the number of all processes in order to form a plan for the object product (S209) and repeats processing steps S203 to S209 by the number of all processes in order to form plans for all of the object products (S210).

FIG. 12 is a flowchart showing a process of the buffer utilization rate calculation unit 1113 which is the process of calculating the buffer utilization rate from a result of execution of the manufacturing line simulation in step S30 in FIG. 10 to decide attainment of the target production amount.

Here, definition of a maximum buffer utilization rate α_{MAX,i} and an average buffer utilization rate α_{AVE,i} of buffers before a process i is expressed in the following formula.

$$\begin{matrix}[ Numerical Formula 1 ] & \\ {α}_{MAX , i} = \frac{{WIP}_{MAX , i}}{{N}_{Buffer , i}} & ( Numerical Formula 1 ) \\ [ Numerical Formula 2 ] & \\ {α}_{AVE , i} = \frac{{WIP}_{AVE , i}}{{N}_{Buffer , i}} & ( Numerical Formula 2 )\end{matrix}$$

Here

WIP_{MAX,i}: Maximum number of partly-finished products [unit] within a simulation object period in buffers before the process i

WIP_{AVE,i}: Average number of partly-finished products [unit] within the simulation object period in the buffers before the process i

N_{Buffer,i}: Number of buffers before the process i (a maximum number of partly-finished products in the buffers) [unit]

The buffer utilization rate is an index indicating to what extent the buffer concerned is actually utilized within the simulation period. For example, in a case where the maximum buffer utilization rate α_{MAX,i} of a certain buffer before the process i is smaller than 1, it indicates that the maximum number of partly-finished products within the period does not reach the number of buffers, it is found that the buffer has never been met within the period, it is found that there exists an unnecessary buffer, and reduction thereof is possible. In addition, in a case where the average buffer utilization rate α_{AVE,i} is small, it indicates that the frequency that the partly-finished product retains in that buffer within the period is small and that buffer can be reduced. On the other hand, in a case where the average buffer utilization rate α_{AVE,i} is large, it indicates that the utilization frequency of that buffer is large, and in a case where the production amount does not reach the target, it is necessary to increase the number of buffers.

Thus, in the buffer utilization rate calculation unit 1113, the buffer utilization rate is calculated in the following procedures. First, the buffer utilization rate calculation unit 1113 reads in the work history information 1156 which is the result of simulation in step S20 (S301).

Next, the buffer utilization rate calculation unit 1113 sums up the number of partly-finished products from the work history information 1156 (S302). Here, as for the number of partly-finished products, the maximum number of partly-finished products WIP_{MAX.i} and the average number of partly-finished products WIP_{AVE,i} of buffers before each process i (the product keeping place) are calculated from the result of simulation.

Next, the buffer utilization rate calculation unit 1113 calculates the maximum buffer utilization rate α_{MAX,i} from the product keeping place information 1154 and the maximum number of partly-finished products WIP_{MAX.i} calculated in step S302 on the basis of the numerical formula 1 (S303).

Next, the buffer utilization rate calculation unit 1113 calculates the average buffer utilization rate α_{AVE,i} from the product keeping place information 1154 and the average number of partly-finished products WIP_{AVE.i} calculated in step S302 on the basis of the numerical formula 2 (S304).

Next, the buffer utilization rate calculation unit 1113 calculates the production amount from the work history information 1156 (S305). Here, as for the production amount, it calculates the average production amount in the object period from the result of simulation.

Finally if the production amount attains the target production amount which has been set in advance, the buffer utilization rate calculation unit 1113 will proceed to step S50. If the production amount does not attain it, it will proceed to step S40 (S306).

FIG. 13 is a flowchart showing a process of the number-of-buffers increasing execution unit 1114 which is a process of executing increasing of the number of buffers in step S40 in FIG. 10 and executing again the manufacturing line simulation.

First, the number-of-buffers increasing execution unit 1114 fetches the buffer utilization rate calculated in S30 and the product keeping place information 1154 stored in the storage unit 115 (S401).

Next, the number-of-buffers increasing execution unit 1114 repeats processing steps S403 to S405 by the number of all processes (S402).

Next, the number-of-buffers increasing execution unit 1114 compares the average buffer utilization rate α_{AVE,i} with an upper limit threshold value UB in the process i, in a case where the average buffer utilization rate α_{AVE,i} is large, it proceeds to step 404, and in a case where the average buffer utilization rate α_{AVE,i} is small, it proceeds to step 405 (S403).

Next, the number-of-buffers increasing execution unit 1114 increases the number of buffers before the process N_{Buffer,i} (S404).

(Numerical Formula 3)

N_{Buffer,i}=N_{Buffer,i}+1 (Numerical Formula 3)

The above-mentioned number-of-buffers increasing execution unit 1114 repeats processing steps S402 to S404 by the number of all processes (S405).

Next, if there is even one buffer which has been increased in the buffers in all of the processes, it will proceed to step 20 and execute the production line simulation. In addition, in a case where there is no buffer which has been increased, it proceeds to step 60 (S406).

FIG. 14 is a flowchart showing a process of the number-of-buffers reducing execution unit 1115 which is a process of executing reducing of the number of buffers in step S50 in FIG. 10, and executing again the manufacturing line simulation.

First, the number-of-buffers reducing execution unit 1115 fetches the buffer utilization rate calculated in S30 and the product keeping place information 1154 stored in the storage unit 115 (S501).

Next, the number-of-buffers reducing execution unit 1115 repeats processing steps S503 to S507 by the number of all processes (S502).

Next, the number-of-buffers reducing execution unit 1115 compares the maximum buffer utilization rate α_{MAX,i} with “1” in the process i, in a case where the maximum buffer utilization rate α_{MAX,i} is smaller than “1”, it proceeds to step 504, and in a case where the maximum buffer utilization rate α_{MAX,i} is “1”,it proceeds to step 505 (S503).

Next, the number-of-buffers reducing execution unit 1115 sets the number of buffers before process N_{Bubber,i} as the maximum number of partly-finished products WIP_{MAX,i} (S504).

(Numerical Formula 4)

N_{Bubber,i}=WIP_{MAX,i} (Numerical Formula 4)

Next, the number-of-buffers reducing execution unit 1115 compares the average buffer utilization rate α_{AVE,i} with a lower limit threshold value LB in the process i, in a case where the average buffer utilization rate α_{AVE,i} is smaller than the lower limit threshold value LB, it proceeds to step 506, and in a case where the average buffer utilization rate α_{AVE,i} is larger than the lower limit threshold value LB, it proceeds to step 507 (S505).

Next, the number-of-buffers reducing execution unit 1115 reduces the number of buffers before process N_{Buffer,i} (S506).

(Numerical Formula 5)

N_{Buffer,i}=N_{Buffer,i}−1 (Numerical Formula 5)

The above-mentioned number-of-buffers reducing execution unit 1115 repeats processing steps S502 to S506 by the number of all processes (S507).

Next, if there is even one buffer which has been reduced in the buffers in all of the processes, it will proceed to step 20 and executes the production line simulation. In addition, in a case where there is no buffer which has been decreased, it proceeds to step 60 (S508).

As the upper limit threshold value UB and the lower limit threshold value LB, upper limit value and lower limit value aiming to hold the buffer utilization rate of each process are set.

Finally, a result of output in step S60 will be described.

FIG. 15 is a schematic diagram showing one example of an output screen 1000. The output screen 1000 shows a display item 1001 for displaying the average buffer utilization rate and the number of buffers that the manufacturing line designing apparatus 110 has prepared and a display item 1002 for displaying the upper limit threshold value UB and the lower limit threshold value LB. The display item 1001 shows the average buffer utilization rate on the left-side longitudinal axis and shows the number of buffers on the right-side longitudinal axis, and shows a process NO on the lateral axis, and displays the buffer utilization rate and the number of buffers in a result of final manufacturing line simulation that the manufacturing line designing apparatus 110 has prepared. In addition, two lines shown on the display item 1001 display the upper limit threshold value UB and the lower limit threshold value LB. In this result, it can be seen that the buffer utilization rate per process is held in a range of the upper limit threshold value UB and the lower limit threshold value LB.

FIG. 16 is a schematic diagram showing one example of an output screen 1010. The output screen 1010 shows a display item 1011 for displaying the maximum buffer utilization rate and the number of buffers that the manufacturing line designing apparatus 110 has prepared and a display item 1012 for displaying the upper limit threshold value UB and the lower limit threshold value LB. The display item 1011 shows the maximum buffer utilization rate on the left-side longitudinal axis and shows the number of buffers on the right-side longitudinal axis, shows the process NO on the lateral axis, and displays a result of the buffer utilization rate and the number of buffers that the manufacturing line designing apparatus 110 has prepared. In addition, two lines shown on the display item 1011 display the upper limit threshold value UB and the lower limit threshold value LB. In this result, it can be seen that the buffer utilization rate per process is held under the upper limit threshold value UB.

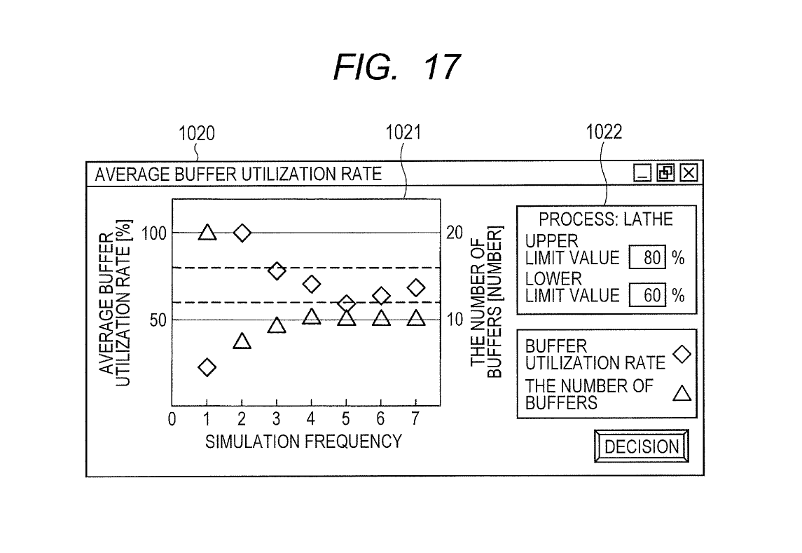

FIG. 17 is a schematic diagram showing one example of an output screen 1020. The output screen 1020 shows a display item 1021 for displaying the average buffer utilization rate and the number of buffers that the manufacturing line designing apparatus 110 has prepared and a display item 1022 for displaying the corresponding process, the upper limit threshold value UB and the lower limit threshold value LB. The display item 1021 shows the average buffer utilization rate on the left-side longitudinal axis and shows the number of buffers on the right-side longitudinal axis, shows a simulation frequency on the lateral axis, and displays transition of the result of the buffer utilization rate and the number of buffers that the manufacturing line designing apparatus 110 has prepared. In addition, two lines shown on the display item 1021 display the upper limit threshold value UB and the lower limit threshold value LB. In this result, it can be seen that the simulation is repeated until the average buffer utilization rate per process is held in the range of the upper limit threshold value UB and the lower limit threshold value LB.

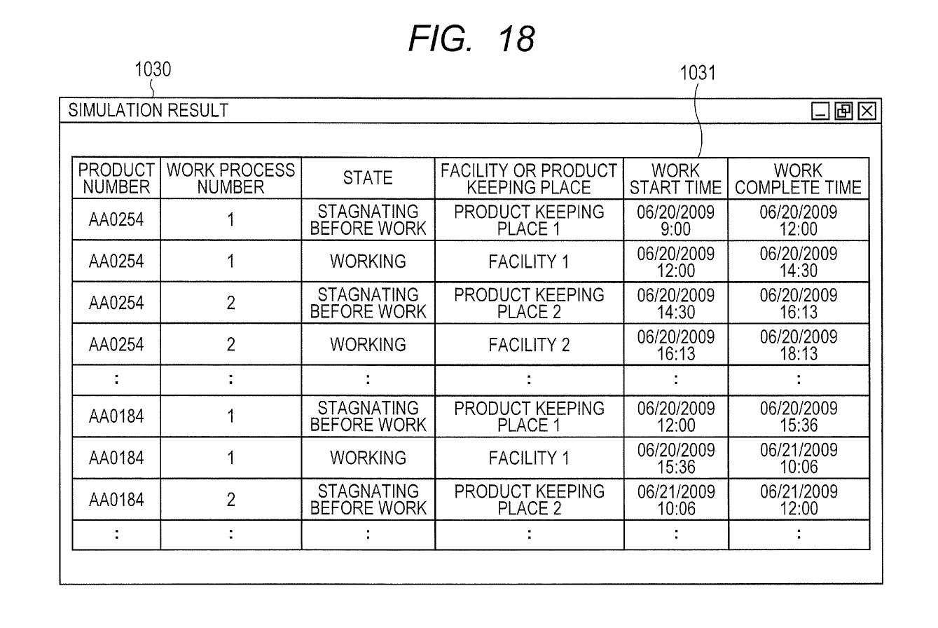

FIG. 18 is a schematic diagram showing one example of an output screen 1030. The output screen 1030 is the result of simulation by the manufacturing line designing apparatus 110. A display item 1031 is provided with the field for registering the product number which is the identification number numbered when the order has been received from the delivery destination who is the customer, the field for registering the number of the work process that the product of the corresponding number is currently being partly finished, the field for registering the state of the process of the product of the corresponding number, the field for registering the number of the facility or the product keeping place that the product of the corresponding number is currently being partly finished, the field for registering the time that the work has been started in the facility or the product keeping place of the corresponding number that the product of the corresponding number is currently being partly finished, and the field for registering the time that the work has been terminated in the facility or the product keeping place of the corresponding number that the product of the corresponding number is currently being partly finished.

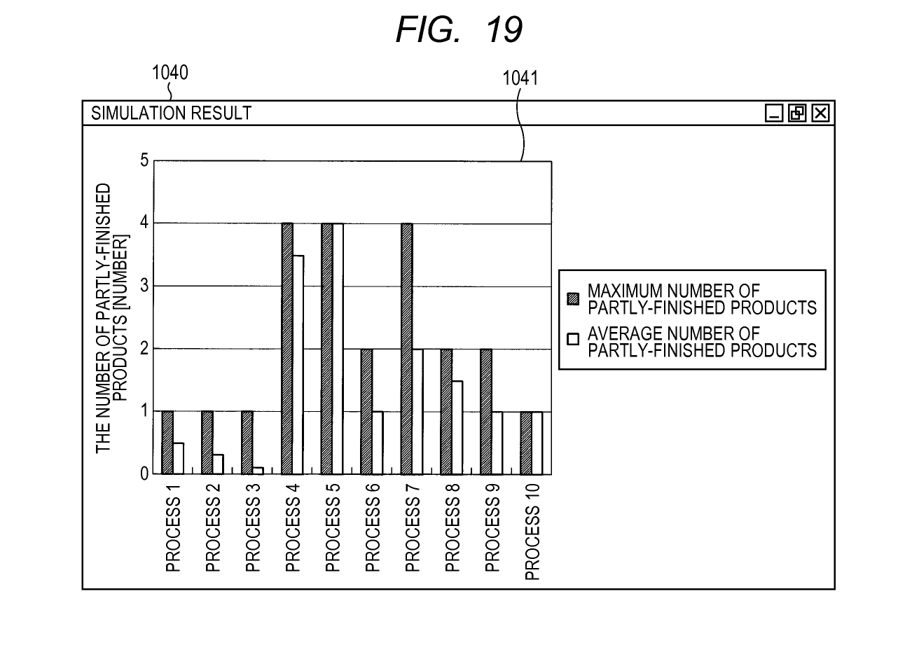

FIG. 19 is a schematic diagram showing one example of an output screen 1040. The output screen 1040 displays the maximum number of partly-finished products and the average number of partly-finished products per work process which are the result of simulation by the manufacturing line designing apparatus 110. A display item 1041 shows the number of partly-finished products on the longitudinal axis, shows the process NO on the lateral axis, and displays the result of the maximum number of partly-finished products and the average number of partly-finished products that the manufacturing line designing apparatus 110 has prepared.

### DESCRIPTION OF SIGNS

110 . . . manufacturing line designing apparatus, 111 . . . control unit, 112 . . . input unit, 113 . . . output unit, 114 . . . communication unit, 115 . . . storage unit, 900 . . . computer, 901 . . . CPU (Central Processing Unit), 902 . . . memory, 903 . . . external storage device, 904 . . . portable storage medium, 905 . . . reader, 906 . . . input device, 907 . . . output device, 908 . . . communication device, 1000 . . . output screen, 1001 . . . display item 1, 1002 . . . display item 2, 1010 . . . output screen, 1011 . . . display item 1, 1012 . . . display item 2, 1020 . . . output screen, 1021 . . . display item 1, 1022 . . . display item 2, 1030 . . . output screen, 1031 . . . display item, 1040 . . . output screen, 1041 . . . display item, 1111 . . . information acquisition unit, 1112 . . . production simulation execution unit, 1113 . . . buffer utilization rate calculation unit, 1114 . . . number-of-buffers increasing execution unit, 1115 . . . number-of-buffers reducing execution unit, 1116 . . . execution result display unit, 1151 . . . received orders information storage unit, 1152 . . . work process route information storage unit, 1153 . . . facility information storage unit, 1154 . . . part keeping place information storage unit, 1155 . . . work time information storage unit, 1156 . . . work history information storage unit.

1. A manufacturing line designing apparatus that designs the number of buffers of a manufacturing line, comprising:
a production simulation execution unit planning the progress of work of all products in information on future predicted orders to be received and preparing work history information;
a buffer utilization rate calculation unit calculating a number of partly-finished products, a maximum buffer utilization rate, an average buffer utilization rate and a production amount of buffers before each process from the work history information;
a number-of-buffers increasing execution unit re-executing the process of the production simulation execution unit by increasing the number of buffers before process that the average utilization rate is larger than an upper limit threshold value in a case where the production amount does not attain a target production amount;
a number-of-buffers reducing execution unit re-executing the process of the production simulation execution unit by using the number of buffers before process that the maximum buffer utilization rate is smaller than 1 as a maximum number of partly-finished products, or by reducing the number of buffers before process that the average buffer utilization rate is smaller than a lower limit threshold value in a case where the production amount has attained the target production amount; and
an execution result display unit outputting a result of final simulation and the number of buffers before each process when no increasable or reducible buffer is left and the process has been finished.

2. The manufacturing line designing apparatus according to claim 1,
wherein the production simulation execution unit
sequentially allocates all products to usable facilities by the amount for a work time, on the basis of information on all object products, object work processes, object facilities and object work times in the information on future predicated orders to be received, and prepares the work history information that partly finishing times of the facilities or buffers before process are recorded in accordance with progress of time.

3. The manufacturing line designing apparatus according to claim 1,
wherein the buffer utilization rate calculation unit
calculates a maximum number of partly-finished products WIP_{MAX,i} and an average number of partly-finished products WIP_{AVE,i} of buffers before each process i from the work history information,
calculates a maximum buffer utilization rate α_{NAX,i} and an average buffer utilization rate α_{AVE,i} of the buffers before the process i by dividing the maximum number of partly-finished products WIP_{MAX,i} and average number of partly-finished products WIP_{AVE,i} by the number of buffers before the process i N_{Buffer,i}, and
calculates an average production amount in an object period from the work history information.

4. The manufacturing line designing apparatus according to claim 1, wherein the number-of-buffers increasing execution unit attains the target production amount by sequentially increasing the number of buffers from a process that the average buffer utilization rate α_{AVE,i} is large in a case where the target production amount is not attained, by using the average buffer utilization rate α_{AVE,i} of the buffers before the process i which can be calculated by dividing the average number of partly-finished products WIP_{AVE,i} within a simulation object period in the buffers before the process i by the number of buffers before the process i N_{Buffer,i}.

5. The manufacturing line designing apparatus according to claim 1, wherein the number-of-buffers reducing execution unit determines the number of inter-process buffers by sequentially reduces the number of buffers from a process that the average buffer utilization efficiency α_{AVE,i} is low by using the average buffer utilization rate α_{AVE,i} of the buffers before the process i which can be calculated by dividing the average number of partly-finished products WIP_{AVE,i} within a simulation object period of the buffers before the process i by the number of buffers before the process i N_{Buffer,i}, and repetitively performing arithmetic operations until the total number of buffers is minimized.

6. The manufacturing line designing apparatus according to claim 1, wherein the execution result display unit displays a buffer utilization rate which is a ratio of a maximum number of buffers to an average number of buffers in a simulation period on an output screen for the number of buffers of each process.

7. A manufacturing line designing method, comprising:
performing a production simulation of sequentially allocating all products to usable facilities by the amount for a work time, on the basis of information on all object products, object work processes, object facilities and object work times in information on future predicated orders to be received, and preparing work history information that times at which the products are partly finished in the facilities or buffers before process are recorded in accordance with progress of time;
re-executing the production simulation process by calculating a maximum number of partly-finished products WIP_{MAX,i} and an average number of partly-finished products WIP_{AVE,i} of buffers before each process i from the work history information, calculating a maximum buffer utilization rate α_{NAX,i} and an average buffer utilization rate α_{AVE,i} of the buffers before the process i by dividing the maximum number of partly-finished products WIP_{MAX,i} and average number of partly-finished products WIP_{AVE,i} by the number of buffers before the process i N_{Buffer,i}, and calculating an average production amount in an object period from the work history information, and in a case where the production amount does not attain a target production amount, increasing the number of buffers before process that the average buffer utilization rate is larger than an upper limit threshold value;
re-executing the production simulation process by using the number of buffers before process that the maximum buffer utilization rate is smaller than 1 as the maximum number of partly-finished products, or by reducing the number of buffers before process that the average buffer utilization rate is smaller than a lower limit threshold value in a case where the production amount has attained the target production amount, and
outputting a result of final simulation and the number of buffers before each process when no increasable or reducible buffer is left and the process has been finished.

8. The manufacturing line designing method according to claim 7, wherein the process of outputting the final simulation result and the number of buffers before each process displays a buffer utilization rate which is a ratio of a maximum number of buffers to an average number of buffers in a simulation period on an output screen for the number of buffers of each process.
